(19) United States
(12) Patent Application Publication
(10) Pub. No.: US 2016/0124937 A1
(43) Pub. Date: May 5, 2016

(54) NATURAL LANGUAGE EXECUTION SYSTEM, METHOD AND COMPUTER READABLE MEDIUM

(71) Applicant: Service Paradigm Pty Ltd, Killara (AU)

(72) Inventor: Mike Fathy Elhaddad, Killara (AU)

(21) Appl. No.: 14/930,326

(22) Filed: Nov. 2, 2015

(30) Foreign Application Priority Data
Nov. 3, 2014 (AU) 2014904408

(51) Int. Cl. G06F 17/27; G06N 5/04

(52) U.S. Cl. CPC G06F 17/2705; G06N 5/04

(57) ABSTRACT

Disclosed is a method, system, and computer readable medium for natural language execution. The method includes, in a processing system: receiving input data indicative of natural language text; using a natural language processor to generate natural language parse information; generating, using the natural language parse information, an input object composite including objects; determining, for the objects of the input object composite and using an object knowledge network, a plurality of interpretation object composites that represent interpretation functions; executing each interpretation function; determining, for the objects of the input object composite and using the object knowledge network, executable object composites that represent executable functions; executing the executable functions thereby generating an output object composite; updating the object knowledge network based on the input and out object composite and the execution of each interpretation and execution function; and outputting, based on the output object composite, output data indicative of natural language text.

### CLAIM OF PRIORITY

This application claims the benefit of priority under 35 U.S.C. §119 to Australian Provisional Patent Application No. 2014904408, filed on Nov. 3, 2014, which is hereby incorporated by reference herein in its entirety.

### FIELD OF INVENTION

The present invention relates to a method, system, and computer readable medium for natural language execution.

### BACKGROUND

Current natural language systems have capabilities of natural text processing including searching, parsing, building semantic knowledge and extracting structured information. However, current systems cannot directly execute the knowledge natural text in a similar fashion which is performed by interpretive programming languages.

There is a need for a new system and method where a user can use their own natural language to dictate to a computer their knowledge and reasoning, wherein the computer progressively builds its own knowledge and reasoning capabilities by immediately executing the user's natural language text based on the pre-accumulated knowledge and reasoning capability. This will allow users to dictate new knowledge in the form that they are most used to which is in natural language and for the computer to execute this new knowledge and provide execution results to the user in natural language.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

In a first aspect there is provided a computer implemented method for natural language execution, wherein the method includes, in a processing system, steps of:

(a) receiving input data, wherein the input text is natural language text;

(b) using a natural language processor to generate natural language parse information based on the input data;

(c) generating, using the natural language parse information, an input object composite including a plurality of linked objects, wherein each object represents a word or group of words of the input text;

(d) determining, for the objects of the input object composite and using an object knowledge network stored in a data store, a plurality of interpretation object composites that represent interpretation functions to interpret the respective word or group of words represented by each object;

(e) executing each interpretation function to modify one or more objects of the input object composite;

(f) determining, for the objects of the input object composite and using the object knowledge network, executable object composites that represent executable functions to execute actions associated with the objects representing the input text;

(g) executing the executable functions thereby generating an output object composite;

(h) updating the object knowledge network based on the input object composite, the output object composite and the execution of each interpretation and execution function represented by the respective interpretation and executable object composites; and

(i) outputting, based on the output object composite, output data indicative of natural language text.

In certain embodiments, the step of determining the plurality of interpretation object composites includes searching the object knowledge network to identify if interpretation object composites that represent the interpretation functions exists for each object.

In certain embodiments, in response to failing to identify the interpretation functions for one of the objects, the step of determining the plurality of interpretation object composites further includes attempting to infer the interpretation object composites that represent the interpretation functions using an inference engine and based on the object knowledge network.

In certain embodiments, the interpretation functions for each object are only executed in the event that the plurality of interpretation functions for all objects of the object composite have been identified or inferred.

In certain embodiments, in the event that the interpretation function for all objects cannot be successfully identified or inferred, the step of determining the plurality of interpretation object composites further includes:

(j) generating and outputting a request to a user for clarification of the respective word or group of words represented by a remainder of the objects which the respective interpretation function cannot be identified or inferred;

(k) receiving clarification text from the user, wherein the clarification text is natural language text;

(l) using the natural language processor to generate the natural language parse information based on the clarification text;

(m) performing steps (c) to (h) to for the natural language parse information generated based on the clarification text; and

(n) inferring or identifying the interpretation function for the remainder of the objects which previously could not be inferred or identified.

In certain embodiments, in the event that at least some of the interpretation functions associated with the clarification text cannot be identified or inferred, the step of determining the executable object composites further includes recursively performing steps (j) to (n) in relation to a further clarification request until the interpretation function associated with the further clarification text can be inferred or identified thereby allowing inference or identification of one or more interpretation functions which previously could not be inferred or identified.

In certain embodiments, the plurality of interpretation functions include:

a. sentence normaliser functions;

b. word and sentence disambiguation functions; and

c. co-reference functions.

In certain embodiments, the method includes normalizing the input data using a text normalizer prior to generating the input object composite.

In certain embodiments, the method includes selecting an object engine from a plurality of object engines to perform steps (d) to (h).

In certain embodiments, each object engine includes a scope definition, wherein the method includes:

generating a plurality of lexical affinity scores for the input object composite based on the scope definition of the plurality of object engines; and

selecting one of the object engines with the best lexical affinity score.

In certain embodiments, the step of determining the executable object composites include searching the object knowledge network to identify if an executable object composite representing the execution function exists for each object.

In certain embodiments, in response to failing to identify the execution function for one of the objects, the step of determining the executable object composites further includes attempting to infer the execution function based on the object knowledge network.

In certain embodiments, each execution function for the plurality of objects is only executed in the event that the execution function for all objects of the input object composite have been identified or inferred.

In certain embodiments, in the event that the execution function for all objects cannot be successfully identified or inferred, the step of determining the executable object composites further includes:

(o) outputting a request for clarification of the respective word or group of words represented by at least some of the objects which the respective execution function cannot be identified or inferred;

(p) receiving clarification text, wherein the clarification text is natural language text;

(q) using a natural language processor to generate the natural language parse information based on the clarification text;

(r) attempting to perform steps (c) to (h) for the natural language parse information generated based on the clarification text; and

(s) in the event that plurality of the execution functions associated with the clarification text are determined and executed, the method includes inferring or identifying the execution function for the at least some of the objects which previously could not be inferred or identified.

In certain embodiments, in the event that at least some of the execution functions associated with the clarification text cannot be identified or inferred, the step of determining the executable object composites further includes recursively performing steps (o) to (s) in relation to a further clarification request until the interpretation function associated with the further clarification text can be inferred or identified thereby allowing inference or identification of one or more interpretation functions which previously could not be inferred or identified.

In certain embodiment, the method includes the processing system executing a software application which performs the steps of the method, wherein the software application is an executable object composite.

In a second aspect there is provided a processing system for natural language execution, wherein the processing system is configured to:

receive input data, wherein the input data is natural language text;

use a natural language processor to generate natural language parse information based on the input data;

generate, using the natural language parse information, an input object composite including a plurality of linked objects, wherein each object represents a word or group of words of the input text;

determine, for the objects of the input object composite and using an object knowledge network stored in a data store, a plurality of interpretation object composites that represent interpretation functions to interpret the respective word or group of words represented by each object;

execute each interpretation function to modify one or more objects of the input object composite;

determine, for the objects of the input object composite and using the object knowledge network, a plurality of execution object composites that represent executable functions to execute actions associated with the objects representing the input text;

execute the executable functions, thereby generating an output object composite;

update the object knowledge network based on the input object composite, the output object composite and the execution of each interpretation and execution function represented by the respective interpretation and executable object composites; and

output, based on the output object composite, output data indicative of natural language text.

In a third aspect there is provided a computer readable medium for configuring a server processing system for natural language execution, wherein the computer readable medium includes executable instructions from executable object composites which, when executed, configure the server processing system to:

receive input data, wherein the input data is natural language text;

use a natural language processor to generate natural language parse information based on the input data;

generate, using the natural language parse information, an input object composite including a plurality of linked objects, wherein each object represents a word or group of words of the input text;

determine, for the objects of the input object composite and using an object knowledge network stored in a data store, a plurality of interpretation object composites that represent the interpretation functions to interpret the respective word or group of words represented by each object;

execute each interpretation function to modify one or more objects of the input object composite;

determine, for the objects of the input object composite and using the object knowledge network, a plurality of execution object composites that represent executable functions to execute actions associated with the objects representing the input text;

execute the executable functions, thereby generating an output object composite;

update the object knowledge network based on the input object composite, the output object composite and the execution of each interpretation and execution function represented by the respective interpretation and executable object composites; and

output, based on the output object composite, output data indicative of natural language text.

In a fourth aspect there is provided a system for natural language execution, wherein the system includes:

the processing system according to the second aspect; and

a user device in data communication with the processing system, wherein the user device is configured to:
transfer the input data to the processing system; and
receive the output data from the processing system.

In certain embodiments, the user device is configured to:

generate the input data based upon one of:
text data input via a first input device of the user device image data captured via a second input device of the user device; and
audio data captured via a third input device of the user device; and

process the output data to generate at least one of:
textual output presented via a first output device of the user device; and
audio output presented via a second output device of the user device.

Other aspects and embodiments will be appreciated throughout the detailed description of the preferred embodiments.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 illustrates a functional block diagram of an example processing system that can be utilised to embody or give effect to a particular embodiment;

FIG. 2 illustrates an example network infrastructure that can be utilised to embody or give effect to a particular embodiment;

FIG. 3A is a flowchart representing an example method for execution of natural language;

FIG. 3B to 3F are flowcharts representing a further example method for execution of natural language;

FIG. 4 is a functional block diagram representing an example system for natural language execution;

FIG. 5 is a functional block diagram of an example GEN engine;

FIG. 6 is a representation of an example of a GEN object;

FIG. 7 is an example representation of an example GEN statement;

FIG. 8 is an example representation of an example GEN question;

FIG. 9 is an example representation of an example GEN composite;

FIG. 10 is another example representation of an example GEN composite;

FIG. 11 is a representation of an example GEN Cause-Effect Composite object;

FIG. 12 is a flowchart representing a method performed by the question execution module;

FIG. 13 is a flowchart representing a method performed by the statement executor;

FIG. 14 is an example of an inferred concept of ontology GEN objects; and

FIG. 15 is an example GEN composite generated by the concept maker component in relation to the example shown in FIG. 14.

### DETAILED DESCRIPTION OF THE EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

### Example Processing System and Network

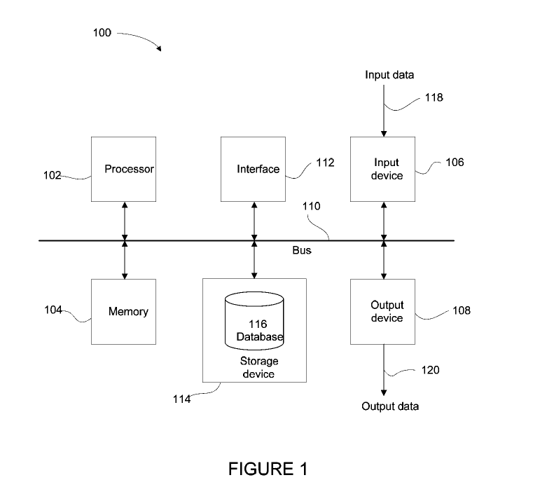

A particular embodiment can be realised using a processing system, an example of which is shown in FIG. 1. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 also can be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc.. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116 and/or the memory 104. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

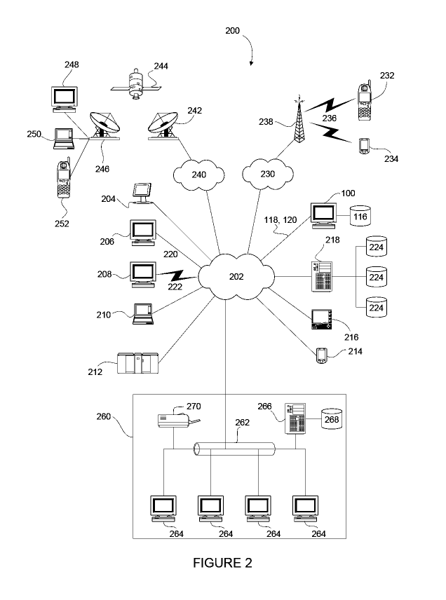

The processing device 100 may be a part of a networked communications system 200, as shown in FIG. 2. Processing device 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with ethernet 262 which connects terminals 264, server 266 which controls the transfer of data to and/or from database 268, and printer 270. Various other types of networks could be utilised.

The processing device 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

### Overview and Example Embodiment

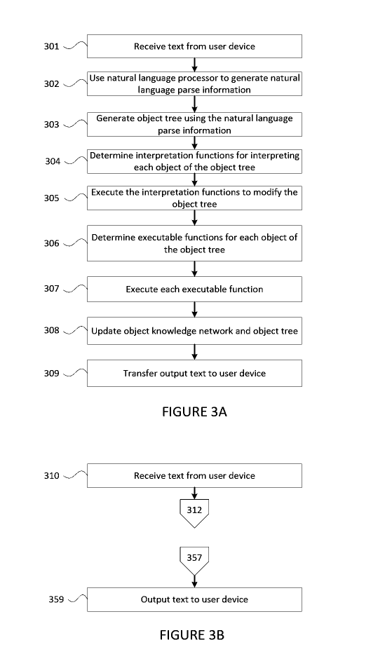

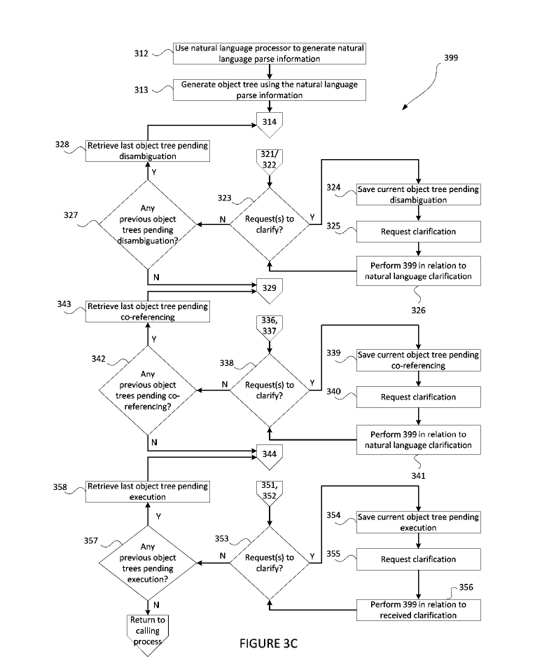

Referring to FIG. 3A there is shown a flow chart of an example method performed by a processing system 450 for natural language execution. The processing system 450 is generally configured by a software application 451 to perform the method as described below.

In particular, at step 301 the method 300 includes receiving input text from a user which can be a device operated by a human user or another system inputting natural language text which can respond to clarification questions. The input text is natural language text. At step 302, the method includes using a natural language processor to generate natural language parse information. At step 303, the method includes generating, using the natural language parse information, an object composite referred to as an input object composite. Object composites are referred to later in this document as a GEN composite. The input object composite is an object composite including a plurality of linked objects, wherein each object represents a word or group of words of the input text. At step 304, the method includes determining, for the objects of the input object composite and using an object knowledge network stored in a data store, a plurality of interpretation object composites that represent the interpretation functions to interpret the respective word or group of words represented by each object. At step 305, the method includes executing each interpretation function to modify one or more objects of the input object composite. At step 306, the method includes determining, for the objects of the input object composite and using the object knowledge network, a plurality of execution object composite representing executable functions to execute actions associated with the objects representing the input text. At step 307, the method includes executing the executable functions. At step 308, the method includes updating the object knowledge network based on the input object composite, the output object composite and the execution of each interpretation and execution function represented by the respective interpretation and executable object composites. At step 309, the method includes transferring output text to the user device indicative of the execution of the executable functions.

Referring to FIGS. 3B to 3F there is shown another flowchart representing a more detailed method performed by the processing system for natural language execution. As previously mentioned, the processing system 450 is generally configured by a software application 451 to perform the method as described below.

In particular, at step 310 of FIG. 3B the text is received from the user device. The method then proceeds to step 312 to perform sub-process 399 shown in FIG. 3C. At step 312, the method includes using a natural language processor to generate natural language parse information. At step 313 an input object composite is generated using the natural language parse information. The method then proceeds to step 314 of FIG. 3D. At step 314 the method includes obtaining the next object from the input object composite. At step 315 the method includes search an object network to identify a disambiguation function for the object. The disambiguation function can be represented by a disambiguation object composite of the object knowledge network stored in the data store. At step 316, the method determines if the disambiguation function was identified. If yes, it proceeds to step 320, if no, it proceeds to step 317. At step 317, the method includes using an inference engine to try and infer the disambiguation function. At step 318, the method includes determining if the disambiguation function was inferred. If yes, it proceeds to step 320, if no it proceeds to step 319. At step 319, the method includes adding a clarification request to a clarification list. As discussed above, clarification may be provided by a user or automated clarification may be provided by another computerised system.

At step 320, the method includes determining if one or more objects remain in the input object composite. If yes, the method proceeds back to step 314 to obtain the next object. If no, the method proceeds to step 321. At step 321, the method includes determining if disambiguation functions have been identified or inferred for all objects of the input object composite. If yes, the method proceeds to step 322, if no the method proceeds to step 323 of FIG. 3C. At step 322, the method includes executing all disambiguation functions identified or inferred for the objects of the input object composite.

At step 323 the method includes determining if there are any requests for clarification for the input object composite. If yes, the method proceeds to step 324, if no the method proceeds to step 327. At step 323, the method includes saving the current object composite pending disambiguation. At step 325 the method includes requesting clarification in relation to the disambiguating the word(s) of the object. At step 326, upon receiving the clarification in natural language, the method proceeds to recursively perform sub-process 399 for the clarification. Once sub-process 399 is recursively performed for the received the clarification and returns from step 357 (as discussed below), the method then proceeds back to step 323 to determine whether any further clarifications are required for the input object composite.

As mentioned above, at step 323, if no requests for clarification are required for the input object composite, the method proceeds to step 327. At step 327, the method includes determining if any previous input object composites of the user session are pending disambiguation. If yes, the method proceeds back to step 328 to retrieve the last (most recent) input object composite pending disambiguation and proceeds to step 314 in order to try and disambiguate the pending input object composite. If no input object composites are pending, the method proceeds to step 329 of FIG. 3E.

Steps 329 to 337 of FIG. 3E are similar to steps 314 to 322 of FIG. 3D except different interpretation functions are being identified, In particular, in FIG. 3D disambiguation functions where being identified/determined to disambiguate the word or words represented by the objects whereas in the instance of FIG. 3E co-reference functions represented by co-reference object composites of the object knowledge network are being identified/determined for each object of the input object composite. Once steps 329 to 337 have been completed, the method proceeds back to step 338. Steps 338 to steps 343 are performed similarly to that of steps 323 to 328. Once no previous input object composites remain pending for co-referencing, the method proceeds to step 344 which is depicted on FIG. 3F.

Step 344 to steps 352 of FIG. 3F are performed similarly to steps 314 to 322 of FIG. 3D except execution functions represented by execution object composites of the object knowledge network are being identified/determined rather than disambiguation functions. The method eventually proceeds to step 353 of FIG. 3B (either via step 351 or 352). Steps 353 to 358 are performed similarly to steps of steps 323 to 328. Once no previous input object composites remain pending for execution, the method proceeds back to the calling process which is generally back step 359 of FIG. 3B but may return to steps 326, 341 or 356 if a recursive execution of process 399 is being performed in relation to clarification. At step 359, the method includes transferring output text to the user device indicative of the execution of the natural language text.

Whilst the example discussed in relation to FIGS. 3B to 3F depicts two sets of interpretation functions being identified for the objects of the object composite (i.e. disambiguation and co-referencing), other types of interpretation functions can also similarly be identified, generated if required, and applied prior to execution by the execution functions in the final portion of sub-process 399. Other interpretation functions are discussed in further examples below which could be additionally implemented in the method shown in FIGS. 3B to 3F.

Whilst the example discussed in relation to FIGS. 3B to 3F depict interpretation functions and execution functions of natural language text, the same method shown in FIGS. 3B to 3F can be used to identify/infer and execute functions to perform text generation, text normalisation, text translation, and any other computation logic entered by user in natural language text. In the text generation example, the algorithm finds the executable functions capable of generating text from the input object composite and then executes to generate the text. In the example, of natural language translation, the algorithm effectively finds/infers the best executable functions for transforming an input object composite of one language into input object composite of another language.

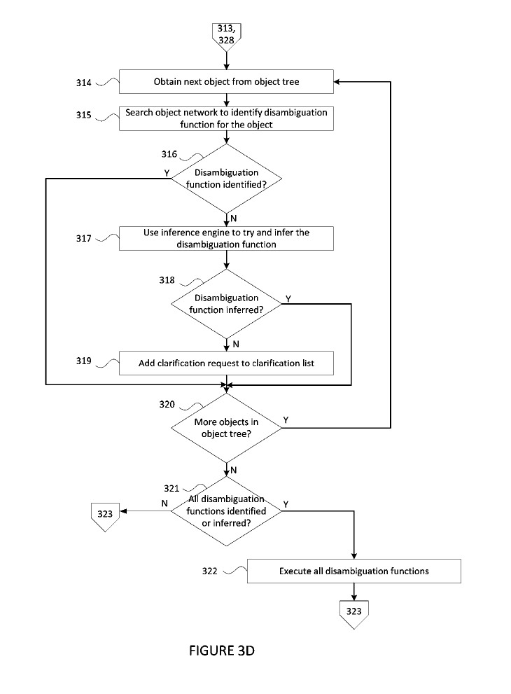

Referring to FIG. 4 there is shown a block diagram of a system 400 for executing natural language. In particular, the system 400 includes a user device 410 in data communication with a processing system 450. Input from the user can be provided via audio 402 or captured image 406. The audio or captured image can be converted by a voice to text converter 404 or an image to text converter 408 to generate input text 410 in the form of natural language. Similarly to converting voice and image to text, device captured events such as user clicks, movements and other device/applications alerts can be also captured to generate input text 410 in the form of natural language.

The input text 410 is then transferred from the user device to the processing system, 450 wherein the transfer occurs using one or more networks. The processing system 450 is configured by the software application 451 which is referred to in FIG. 4 as the Natural Language Composite GEN Engine. At the processing system, a text normalizer 452 which is a software component of the software application 451 processes the received text 410 to generate normalized text 454 which is then transferred to a text to GEN converter 456 which is a software component of the software application 451. The text to GEN converter 456 generates the input object composite which is herein referred to as a GEN composite as will be discussed in further detail below. The text to GEN converter 456 calls a natural language processor 470 to generate an object parse tree and an external dictionary and ontology module 480 to generate the GEN composite. The calls may be made via an API interface. The GEN composite 458 includes a plurality of GEN objects connected together to represent the input text and the relationship between words and groups of words that are part of the input text from the user. The text to GEN converter 456 also disambiguates, co-references and normalises all objects in the input object composite 458.

The generated GEN composite 458 is transferred from the Text to GEN converter 456 to a communicator module 460, a software component of the software application 451, which determines a GEN engine 462 (a software component) from a plurality of GEN engines 462 to transfer the GEN composite 458 for execution. In particular, the processing system 451 can include a plurality of GEN engines 462 which specialize is various domains, therefore the communicator 460 attempts to select the most appropriate GEN engine 462 for the specific GEN composite 458. Additionally or alternatively, as shown in FIG. 4, the communicator 460 may transfer the GEN composite 458 to an alternate GEN engine 490 hosted by a remote processing system in communication with the processing system 450. In this manner, the remote processing system together with the processing system form a distributed processing system.

More specifically, the software application 451 configures the processing system 450 to generate a plurality of lexical affinity scores for the input object composite based on a scope definition of the plurality of object engines. The processing system 450 configured by the software application 451 selects one of the object engines to transfer the input object composite based on the plurality of lexical affinity scores. For example, the scope of one of the object engines which generated the best lexical affinity score can be selected.

The GEN engine 462 executes the GEN composite 458 as will be discussed in more detail below such that the natural language text input by the user is executed. Control then returns to the communicator 460 which receives an output GEN composite 458 which is indicative of the executed natural language text. The output GEN composite 458 is transferred to a GEN composite to text converter 464, a software component of the software application 451, which converts the output GEN composite 458 to natural language text understandable by the user. Output data 412 indicative of the generated text is then transferred from the processing system 450 to the user device 410 via the one or more networks. In the event that the output needs to be audibly presented, the user device 410 may utilize a text to voice converter 414 to generate output audio data 416 which can then be presented to the user. Alternatively the raw text data 412 can be presented to the user via the user device 410. As shown in FIG. 4, the user can select to use a particular processing system to execute the natural language text, wherein the selection is made from an expert system directory 495 which each processing system can register therewith.

In a preferred form, the software application 451 can be an executable object composite.

### Further Examples

### Generic Execution of Natural-language (GEN)

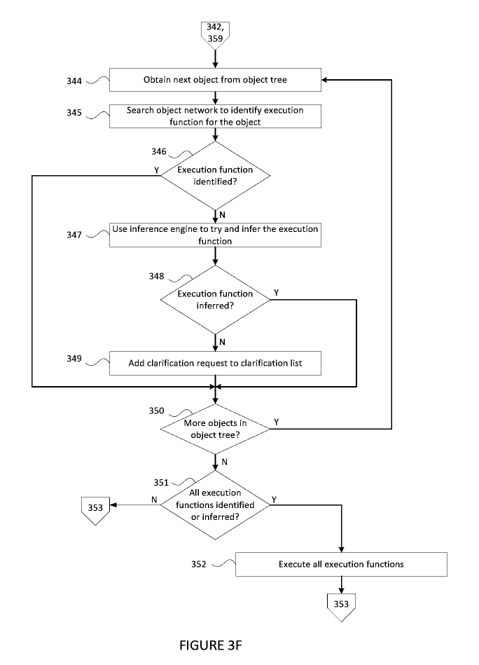

The implementation of the described method and system is based on the concept of a Generic Execution of Natural Language which is an interconnected network of objects called a GEN object which can be represented as a coherent network and can represent any knowledge or text which can be executed. Referring to FIG. 6 there is shown a representation of a GEN object which includes the following attributes:
Text: A string field which represents the lemma and word sense of the word(s), which also acts as an identifier of the GEN object. The text attribute is not a globally unique identifier; it is only unique by value and position within the coherent composite that it belongs to.
Value: A container for any value for the GEN object. For example, it can hold the actual numerical value for a GEN object representing the “quantity” of the text.
Adjoin: Another GEN object that represents a relationship between two GEN objects. The Adjoin allows the creation of a network of interconnected objects to become a Composite GEN object 458 as will be discussed in further detail below.
Usage Scenario: a depiction of the intended use for a GEN object, such as:
   Exe—is the Executable Usage scenario for any dynamically executed Usage Scenario. A Gen composite object 458 created for a representation of Input text or new inferred knowledge can have a usage scenario=exe
   Fact—is a specific instance of knowledge that is created and updated as a result of execution of a GEN object.
   Type—is an ontology type of knowledge which may be loaded from external sources such as dictionaries and also created and updated as a result of execution of a GEN object.
   Solution—GEN objects used to hold implementing algorithm and data

Usage scenario may be implemented as an attribute as shown in FIG. 6 or by sub-classing of which Exe, Fact, Type and Solution would be subclasses to GEN object.
Coherent ID: The coherent ID is a structured identifier that is used to mark GEN objects that are part of a coherent logic or information. It has the structure that allows sub pieces of knowledge to be identified in the semantic context of the knowledge that it is part of
Weight: A structure that represents the numerical double precision value of 3 sub values that are an incremental factor to the weight of the GEN object;
Strength: An incremented/decremented percentage calculated based on contribution to the owner GEN in providing an end result as compared to the total number of attempts to include in a result;
Confidence: An incremented/decremented percentage as a result of contributing to a known correct result compared to the known total correct and incorrect result.
Priority: An incremented/decremented percentage as a result of the word affinity to the domain as well as what is required be executed before others.
Executer: An optional link to a hand coded method/class that executes basic functions for the GEN object. Typically that they are needed to access the API of external system or library 560. Usually the GEN object at the edge of the GEN composite object 458 has a manually coded executor, while a majority of the other GEN Objects are linked to a GEN composite 458.
Word Annotation: a complex structure that represents information about a particular word, for example:
   Part Of Speech (POS) such as S, NP, VP, DET, etc.
   Gender
   Named Entity such as persons, organisations
   The role in the sentence using the AAM Word Triplets: Actor (the doer of an action), Action and Matter (the object of the action) including any complements and groupings to the Word Triplets.
   The Semantic Context information of the sentence
Execute: This is the entry point for executing any GEN with Executable (exe) Usage Scenario. This is a generic method that has input parameters representing the request type, the parameters which are the GEN objects that are needed for the execution and returns a result which is also a GEN object.

### GEN Composite

GEN objects can be interconnected together to form a coherent composite of a GEN object. The GEN composite 458 is a set of interconnected GEN objects that have the same Coherent ID and Usage Scenario. A GEN composite 458 has the same physical interface of GEN object and therefore it appears to an external caller as a GEN object. However, the GEN composite 458 has the capability to represent the combined capabilities of children GEN objects that are part of that composite and coherent structure.

The GEN composite 458 can represent complex language structures such as sentences. For example, it can represent a statement in a natural language. The GEN composite 458 is effectively an executable software component that has the logical representation of a statement which includes GEN objects interlinked by adjoins and kept coherent by a coherent ID structure.

The GEN composite 458 supports statements and questions either made by the user or internally generated as part of the internal GEN engine inference. Statements are sentences that are not questions and can have forms such as suggestion, commands condition, cause effect and clarifications. The GEN composite 458 structure can also support all type of questions such as closed question such as yes-no and identify a piece of information, or open ended questions such as the questions that requires explanation or reason in order to provide am answer.

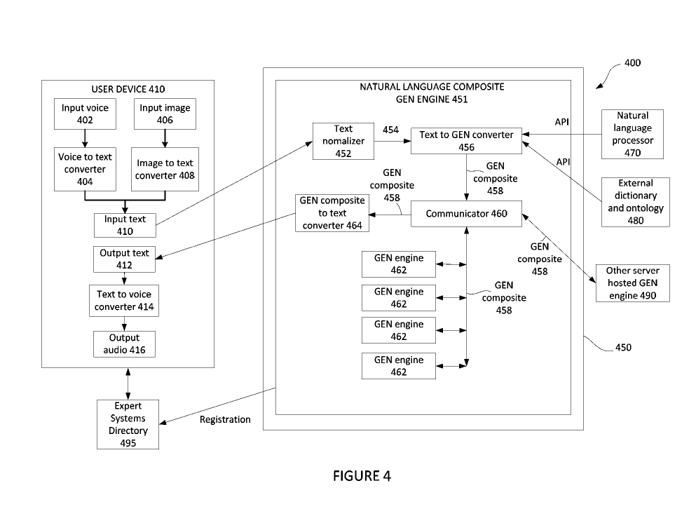

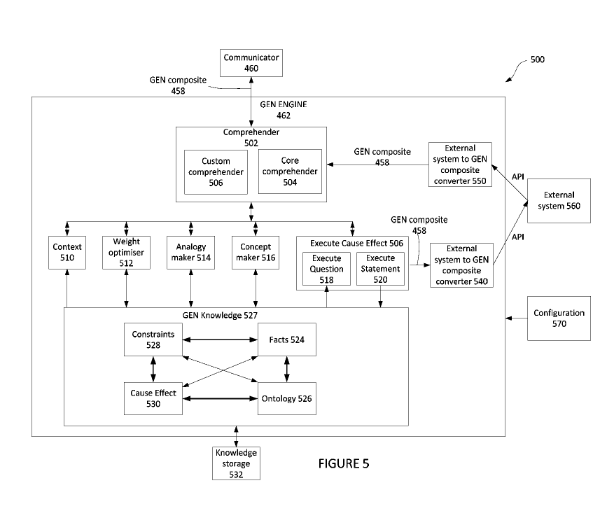

As an illustration of a GEN composite 458 is shown in FIGS. 7 and 8. FIG. 7 depicts a GEN statement, where the GEN statement is made of GEN Actor(s), GEN Action(s) and GEN Matter(s). The Actor which is the Subject or Agent refers to the doer of the Action; the Action is usually a verb which refers to what is performed by the doer; and Matter refers to the Object that was performed on by the doer.

When an Actor, Action and Matter may have Adjoins which points to other GENs then the AAM annotation is supplement with the Group Annotation since the GEN represents more than one GEN. for example, when an Actor has Adjoins to other Adjoins, then it becomes an Actor Group. An Actor Group may contain the main Actor and/or Actor Complements or even another Actor Group if there is more than one Actor.

FIG. 8 shows an example of a GEN composite 458 that represents an actor type question with a word such as “who” at the head of the Question. For example “Who understood this matter,” where the Action is representing “understood” and the Matter and its adjoins are representing “this matter”.

An Action type of Question follows similar structure where the head of the question can be “what-do”, where the Actor is defined and the Matter also defined. For example “What Mike did to his savings?” where Mike is the Actor and “his savings” is the Matter.

Matter type of Question follow the same paradigm where there is a question word at the head which two of the triplets available (in this case, is Actor and Action) while Matter is missing.

The GEN composite 458 is considered a normalised GEN composite 458 when it is a single and complete canonical form of the Word Triplets (AAM) and cannot be broken further into more Word Triplets while it can have links to other normalized GEN composite 458 in order to allow for more complex structures.

### GEN Composite Statement

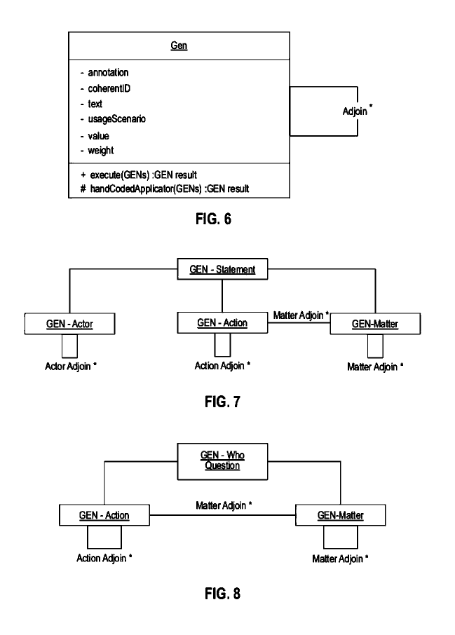

An example of a GEN composite statement is shown in FIG. 9 which represents the sentence “Mike has a savings account”. FIG. 9 shows the following:
1. GEN Composite 458, is a representation of the whole sentence because of all the sub-GENs it contains.
1.1 The doer/performer of an action is marked with annotation that is Actor and in this example the Actor is indicated in the Text=“Mike”
1.2.1 the verb is marked with Action annotation and in this example the Action is as per the Text=“has”
1.2.2.2 The object of which the action is performed on is marked with annotation Matter and in this example, it has the text of=“account”

A GEN with annotation Actor, Action and Matter can have complements, for example 1.2.2.1 “Savings” is a Matter Complement for the 1.2.2.2 “Bank”. The Complement in this case complements the account with its type. Complements are effectively additional words that can be supplementing Actor, Action or Matter.

The 1.2.2 “savings account” is a GEN Composite 458 that has the annotation Matter Group and is connected to both 1.2.2.1 and 1.2.2.2. An Actor Group, Action Group and Matter Group can have connection to the main object in the group (Actor, Action and Matter respectively) and Complements to the main object and Groups of the same type of annotation. In some cases, a Group may have connection to a Group of different AAM annotation, for example an Action Group may have a connection to the Matter Group.

All GEN Objects in a GEN Composite 458 that belong to a coherent Statement will have the same coherent ID and the Usage Scenario to ensure the coherence of the sentence.

As mentioned before, some GEN objects at the leafs of the coherent GEN Composite 458 may require hand coded implementation in a programming language. The hardcoded implementation is required for GEN Objects that are not GEN Composite 458 and with Action annotation. For example, consider the text “Mike deposited $10 in has bank account” where we assume in this example that “deposit” is not a GEN Composite 458, then “deposit” would require a programming language implementation of the “deposit” action. This programming language implementation would add $10 to the balance of the account balance. Similarly, withdraw would require programming language implementation for the GEN Action “withdraw” as in the sentence “Mike withdrew $100 from his savings account”.

As different example of an Action, the “transfer” GEN Action will not require hand coded implementation if “transfer” is defined in a statement such as “Transfer money is withdrawing money from a bank account and depositing it into another bank account”. Transfer Action execution in the example is defined by executing the “withdraw” Action followed by the “deposit” Action in the respective accounts. Or in other terms, since a GEN Composite 458 has the same physical interface as a single GEN, the GEN Action “transfer” need not be to be coded in a programming language and can replaced by a GEN Composite 458 that call GEN Actions to perform “withdraw” and “deposit” function, resulting in the “transfer” function being executed. In this example the Action is called an Augmented Action rather than a programming language coded action.

Continuing the above example, when a “transfer” transaction is initiated by an operator, for example “transfer $20 from Mike's savings account to Simon's”, the GEN Action is “transfer”, wherein the system does the following to execute the transfer:
Performs co-referencing to resolve Mike, Simon and possessive article in the sentence
Locate the best executable to perform the action, as per the above examples, it will find the Augmenting “transfer” GEN Composite 458 represented by the text “Transfer money is withdrawing money from a bank account and depositing it into another bank account”.
It co-references the Augmenting “transfer” GEN Composite 458 with the specific of the action. In the above example, it will be which is which accounts (Mike & Simons savings account) and the amount of money ($20).
Executes the co-referenced augmenting “transfer” GEN Composite 458 as described later.

Adding further to GEN Composite examples, the suggested programming language implementation of “deposit” action above may not be needed if “deposit” is described in natural language at more detailed level. It could be also replaced by a GEN Composite Action that could have more granular actions such as “add” in an Action Group such as in the sentence “deposit is adding money to account balance” which does not require hardcoded implantation as the “add” action is part of the GEN engine 462.

The GEN Statement for “Mike withdrew $20 from his bank account” is ambiguous without clarifying each GEN by properly connecting it to its correct definition (i.e. word sense). For example, Mike could be a person or a microphone. It is the function of the GEN Word Disambiguation Component (not shown) to determine the sense of the word. When Mike is determined to be a person, it is also important to also determine which Mike among all people called Mike is being referred to. Disambiguation and co-referencing would be required for all words in the statement above to determine which account and what type of transfer will take part of the execution. Word disambiguation and co-referencing removes the uncertainty by identifying the correct word sense for a GEN Object and adds a “hasRef” Adjoin to the correct GEN in the knowledge base 527. This will be further described herein.

### The Execution of a GEN Composite

The GEN Engine 462 (described later) performs execution on a GEN Composite 458. This approach sub statements or sub-GEN Composite 458 to be executed first and the result of that execution is available to upper and later parts of the GEN Composite 458 that have the same Coherent ID structure.

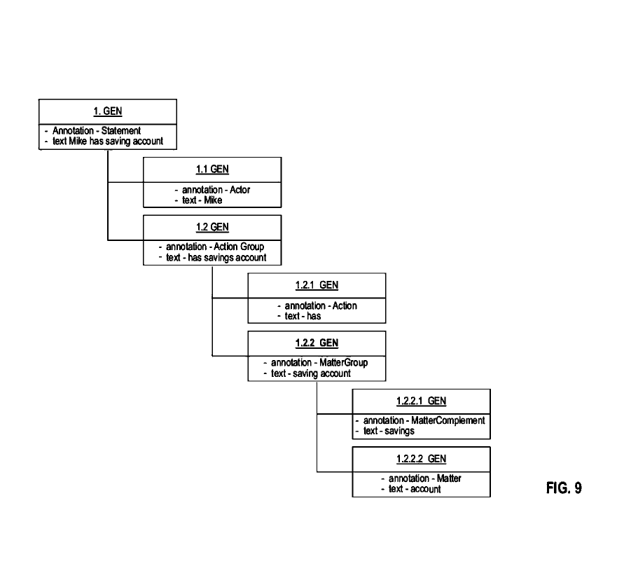

Referring to FIG. 10 there is shown the outcome Execute Statement 518 and the reference Adjoins that are created by the Word Disambiguator and co-reference. In the above example, “Mike” as represented in the Statement is linked to “Mike Elhaddad” which is a known Fact 524 in the Knowledge base 527 through the Adjoin “hasDef”. “Mike Haddad” is determined by the Word Disambiguator as of type “person” as shown with the Adjoin labelled “hasType”. The GEN object with text=“Account” and usage scenario=Fact is the savings account referred to in the Statement; this account has a “balance” with a value of $100.00.

### GEN Ontology

Ontology 526 is a formal representation of a set of concepts which are connected via any of the Adjoins that are described below as Facts 524 or Ontology Adjoins 526. The GEN ontology 526 is a generic and thin layer of sense disambiguated GEN objects of usage scenario=Type. The GEN ontology 526 is part of the start-up package of the GEN Engine 462 that is sourced from upper ontology such as WordNet or could be created by domain experts for a specific domain. It could be also further handcrafted by executing a number of generic natural language statements that have the effect of creating Ontology GEN Objects 526 for that domain.

### GEN Facts

Facts 524 are actual specifics (rather than generics) that represent the state or result of execution of GEN Composites 458. The Facts 524 are GEN objects that have a usage scenario of Fact 524 and are connected via any of the Adjoins described below as Ontology 526 or Fact Adjoins 524. A set coherent facts of a coherent meaning can also be joint by Correlation ID so that they can also be treated as coherent piece of knowledge which can be asserted or returned as a result of a question.

### Adjoins

An Adjoin is a GEN object, wherein their text is limited to the values shown below. They are bidirectional relations and have the following type of Annotations that are set while creating Facts 524 and Ontology 526.

The Adjoins Annotations include:
Modal, such as: may, can, shall, should, would, must, certain
Negation, such as: not
List, such as: ordered, any, all, one
Elaboration, such as: for example, such as, including
Coordination, such as: together, independent, before, after, when event, while event
Cardinality of GEN such as: only 1, 0 or 1, 0 or many, few, range (3-5)
Relativity of GEN such as: from, to, in: on, out, by, of
Relative size: more, less, best, worst
Location of the GEN such as: here, there, far, near, specific, beside, area
Time of the GEN such as: current, past, future, until, specific, period, to-be, just-action
Frequency such as: always, usually, often, sometimes
Emphasis such as: very, greatly, hardly
Causality, because, action-to-action
Opposition such as: but, even though, despite, the unexpected
Control: governed by, constrained by, works in a certain way
Abstraction: simply, generally, summarizing
Possessive: owned by, belongs to, object for

Fact and Ontology Adjoins, the Facts and Ontology Adjoins which are donated relationship pairs from A to B, including:
hasType: B is a type for A or A specific instance of B. A is a FACT for Type B
hasPart: Bis part of A. Or A has a part B
hasItem: B is an item in A. Or B is owned by A.
hasAction: A have action B. What B can do/done/doing for A
hasActionOn: A is an action can do/done/doing on matter B.
atLocation: A is at B, or B has A
atTime: Event A is at time B
hasAttribute: A has B as a property
similarTo: A and B have similar meanings Acts as a bridge for coherent semantics.
sameAs: A and B are same or have same meanings
oppositeTo A and B are opposites to each other.
hasSuper B is super class of A. Or A is a subclass of B. Opposite is “hasSub”
definedAs B is a more elaboration of A. Acts as a bridge for coherent semantics.

All the above adjoins are created by rules defined the GEN Expert Engine 462 or Sentence Normalisation engine as described later in this document.

Executable adjoins, the Executable Adjoins which are donated relationship pairs from A to B, including:
hasDef A is an Executable that has a Fact B.
hasRef A referring to B. Adjoin is created by the Word Disambiguator and Co-Referencer
hasChild A is a GEN Composite that has B as a child or B has parent A. Adjoin is created by the Text to GEN Converter 456 or an Inference Component such as the Analogy Maker 514.
   GEN Composite with Constraints Annotation (GEN Constraint)

The GEN Constraint 528 is similar to a GEN Statement in structure. For example, the “Transfer” action can be further constrained by a natural language statement such as “Transfer money can only be requested by the account holder of the withdrawal action or a bank operator”. The Sentence Normaliser described later uses patterns to recognise different sub-types of Statements such as Constraint 528. In the above example, modal words such “can only” will be recognised by the Sentence Normaliser as a constraint; The Sentence Normaliser sets its annotation as Constraint 528 and keeps the GEN Composite 458 in the GEN knowledge 527 for checking by the Comprehender 502 during Statement Execution.

GEN Composite with Question Annotation (GEN Composite Question)

This is similar to a statement wherein a question can also be represented as a GEN Composite 458 but with different structure. There are many types of question such as:
Binary question that could lead to Yes or No Question, example: “Does Mike have savings account?”
Actor type question that could lead to the Actor as the answer example: “Who just opened the savings account?” The answer is “Mike” from the previous example which is an Actor.
Matter type question that could lead to the Matter as the answer for example:

“Which account did mike open?” The answer is the GEN Matter Complement which is “savings”.
Reason type question that could lead to an explanation such as “Why Mike opened savings account?” or “How Mike is securing his saved money?”. The answer is related to a cause and effect which is described later herein.

The Binary, Actor, Action and Matter type of question can be answered by traversing the Facts and Ontology 524, 526. As an example of how GEN Composite 458 represents the Binary question “Does Mike have savings account”, in order to obtain the answer to the Question, each GEN object in the GEN Composite Question is executed, which effectively traverses the Facts 524 starting from the Actor “Mike”, all the way to finding an “Account” that has a “Savings” attribute.

### Combining GEN Question and GEN Statement in a GEN Cause-Effect

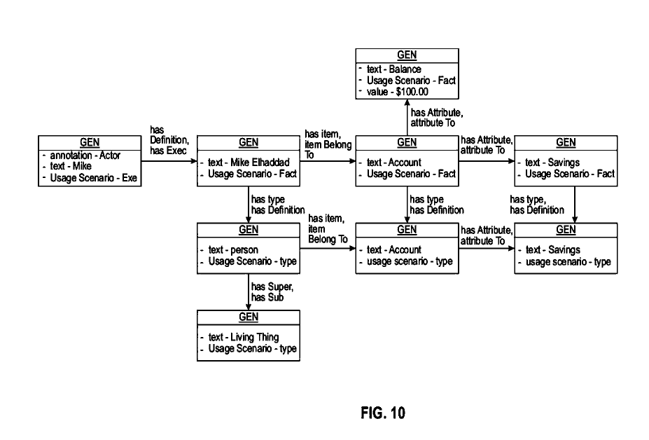

Referring to FIG. 11 there is shown the following cause-effect statement “When a person wants to secure his savings, the person may deposit his savings in a bank account.” has a Cause “When a person wants to secure his savings” and an Effect “the person may deposit his savings in a bank account” The Sentence Normaliser Component has the responsibility to recognise the Cause-effect pattern and create the GEN Composite 458 with the Annotations that represents a Cause-Effect(the GEN Cause-Effect could also be created from inference by the Concept Maker and the Analogy Maker Component 514). When a Cause-Effect 530 is created, it is atomically loaded in the GEN Knowledge 527 and becomes immediately available for execution.

Referring to FIG. 11, this shows a GEN Composite 458 with Annotation=Cause-Effect, it has two main GEN Composites 458:
A GEN Question (not all sub GEN Composite 458 of the Question are shown) that has the Annotation=Cause, it has the GEN Composite 458 to execute the Question and obtain answer for “Does the person want to execute his savings?”
A GEN Statement (not all sub GEN Composite 458 of the Statement are shown) that has the Annotation=Effect and has the GEN Objects execute the Statement.

The premise is that the GEN Cause-Effect 530 will execute the GEN Statement (Effect) if the Question (Cause) executes and returns true.

In addition to the examples given above, Cause-Effect 530 can be also be used to set the Session Context 510 values and domain values such as weight attributes. For example, an statement by a high confidence active voice of “There is a fire alarm in building A”; will trigger a matching cause which will have the effect to increase the active priority of “safety” and “fire services” domains. A step down statement from the active voice will trigger matching case to reduce the priority in such domains.

### The GEN Engine

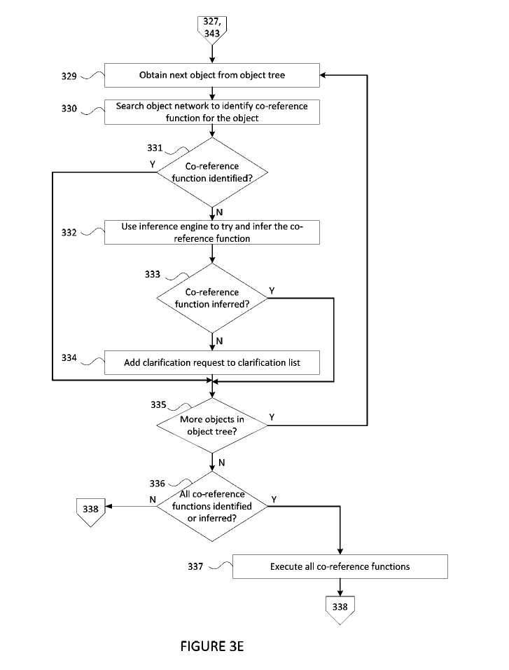

Referring to FIG. 5 there is shown a representation of an example of the GEN Engine 462 which is an atomic and complete execution engine that is based on GEN Objects. It takes input of GEN Composite 458 and it has the ability to classify that input as Question, Statement, Cause-Effect 530 or Constraint 528. The GEN Engine 462 executes the input Statements, stores GEN knowledge 527, performs inference on its knowledge and answers Questions from the GEN Knowledge 527.

### Comprehender

This is entry point to the GEN Engine 462. It is a GEN Objects based component that has the GEN Interface and is built from GEN objects. It receives GEN Composite 458 with Exec Usage Scenario and with Annotation such as Statement, Cause-Effect 530, Constraint and Question. The Comprehender 502 has a custom component 506 which in turn can be a GEN Engine 462 or a traditionally programming language coded component 504 or both. The Comprehender 502 has a standard core component which performs input classification, Question and Statement Chaining as described below. The Word Disambiguator and Sentence Normaliser are GEN Engine 462 implementation examples that have their own Comprehender custom code 506 in addition the Comprehender core code 504.

The Comprehender 502 stores GEN Composites 458 that are deemed needed for future execution, for example, the Comprehender 502 identifies Cause-Effect 530 and Constraints 528 and stores these in the GEN Knowledge 527.

The Comprehender 502 calls components to execute questions, statement and make inferences, as will be discussed in more detail. The Comprehender 502 also calls the optimiser 512 with GEN-Composite 458 and the corresponding expected results. The optimiser 512 uses optimisation algorithms such as Evolutionary Algorithm or any other local optimisation search to optimise the relevant Weights of GEN, Multiplier Factors, the minimum acceptable scores and GEN Composites 458.

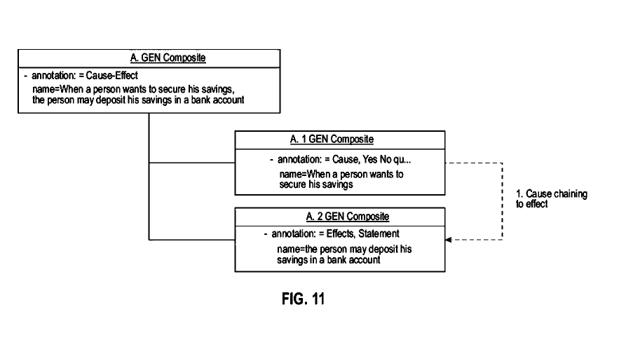

Referring to FIG. 12 there is shown an algorithm employed by the Comprehender 502 in order to be able answer questions. The diagram shows a goal driven algorithm of which it has its own internal flows as well as calling function such as Execute Question 520, Analogy Maker 514, Execute Constraint and GEN Matcher which are described further herein.

There are cases when a Question does not have a direct answer in GEN Knowledge 527 and activities such as chaining and inference by calling the Analogy Maker 514 may be required to answer the questions. Also, when executing a Statement, it cannot start nor complete before satisfying all applicable Constraints 528 and Common Sense Logic. Asking a Question may also lead to executing Statements to updated the GEN Knowledge 527 with inferences. After the execution of a Statement, the GEN Knowledge 527 may change and in which may start to trigger Causes-Effect sequence of reaction and inference of conceptual patterns may start to emerge. The core Comprehender 502 component performs this role of chaining and initiating inference in order to execute the input GEN Composite 458.

### Execute Question

The Execute Question Component 520 is invoked from the Comprehender 502. The Execute Question 520 has the responsibility to prepare the question for execution and then call the execute method of the GEN Composite 458. Once the GEN Composite 458 execute method is called, for binary and object type of questions, it follows the Actor-Action-Matter GEN execution sequence for all the GEN Objects in the GEN Composite 458.

The Execute Question 520 selects the execution method for each GEN in the GEN Composite based on
Type of execution; such as question or statement execution, disambiguation, co-reference, normalization, text generation, etc.
The GEN object name as defined by the words sense keys and the GEN objects annotation which in turns determines the selection of:
   The augmented executable functions which have preference over programming language executable functions as they represent further elaboration of the word by the users
   The programming language executable functions if defined in the configuration file
Type of speech as per the Semantic Context information

If the executable function cannot be resolved for one of the objects, then the inference functions are called with a goal to find the best executable function for the GEN object.

The Statement and Question execute methods are different as the main purpose of the Execute Statement 518 is to create new Facts or Ontologies by executing the Actions while the Question main purpose is to retrieve matching GEN Objects from the Facts 524 and Ontology 526.

The Question execute methods do the following:

1. First iteration, co-reference resolution. This pass has the same logic as the first pass of the Statement execute methods which does the following:
a. For every pronoun, start with the current sentence and search for a noun or noun phrase with matching gender, plural. If found then add a hasRef Adjoin to point to the found noun and noun phrase. If not found then retrieve sentences from the Session Context 510 and apply this logic on the retrieved sentences with higher weight to more recent sentences.
b. For every possessive adjective, start with this sentence and search for a noun or noun phrase with matching attributes such as: voice, named entity, gender and plural. If found then add a hasRef Adjoin to point to the found noun and noun phrase. If not found then retrieve sentences from the Session Context 510 and apply this logic on the retrieved sentences with higher weight to more recent sentences.
c. For every determiner “the”, “this”, that”, “these” at the start of a noun phrase, start with this sentence and search for noun or noun phrase, use the GEN Matcher to match. If matched then add a hasRef Adjoin to point to the matched noun and noun phrase. If not found then retrieve sentences from the Context 510 and apply this logic on the retrieved sentences with higher weight to more recent sentences.
d. For the Actor and Matter, if it is a specific instance such as named entity, then look the Session Context 510 for the last mention of the named entity and identify the Fact 524 referenced by the last mention, add a hasRef from the Actor or Matter to the found Fact 524.
e. For every other GEN in the sentence, identify
   The most appropriate GEN Ontology Type in the domain.
   The most appropriate GEN Ontology Type with affinity to same or similar Actor and Matter.

Convert the GEN Question into a goal statement that effectively turns a question to a binary question but in a GEN Statement structure.

2. Second iteration, based on the type of a question, it traverses the GEN Knowledge 527 and filters out the GENs that do not match the question, for a binary question:
a. Finds the Facts 524 that matches the Actor, and then filter out all the facts that do not match the Actor Complement.
b. For every filtered Actor, finds the Facts 524 that match the Action and
c. For every filtered Action, filter out all the Facts 524 that do not match the Action Complement.
d. For every filtered result from the above, finds the Facts that match the Matter
e. For every filtered Matter, filter out all the Facts 524 that do not match the Matter Complement.

For every step listed above, it important to note:
If GEN in the GEN Composite Question has adjoin “hasRef” then the execute methods will use the referenced GEN as the relevant Fact 524 or Ontology 526 for filtering.
When a match is found, the match is scored based on the inverse of the distance between the GEN in the Question and the found GEN. A weighted average score is kept for every match found until all matched or match is not found which clears the weighted average score and terminates the search.

The Execute Question 520 may return more than one matched result. The number of results returned is a configurable parameter as well as the minimum acceptable score for an answer. The Execute Question 520 returns maximum number of acceptable results sorted based on the best weighted average scores.

### Statement Chaining

The Statement Executer is invoked from the Comprehender 502, It is a GEN component. The Statement Executer is a GEN component that has the GEN interface, its execute method takes any GEN-Composite 458 with Annotation Statement and Usage Scenario as Exec as input parameter.

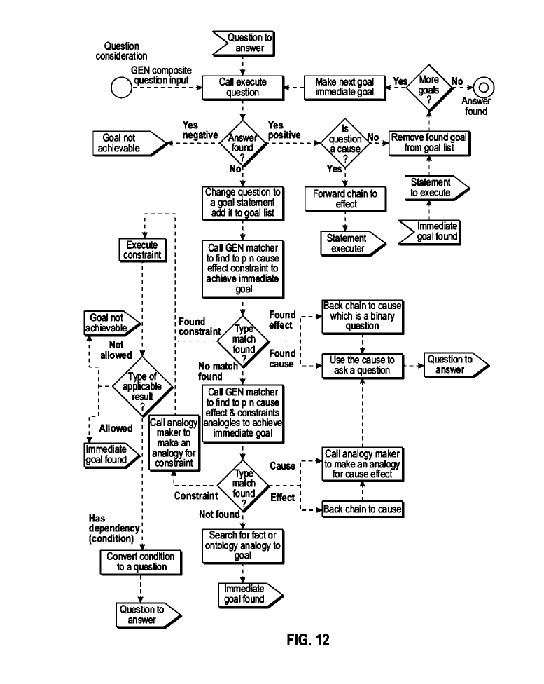

Referring to FIG. 13 there is shown the Statement Chaining diagram algorithm that has its own internal flows as well as calling function such as Execute Statement 518, Concept Maker 516, Execute Constraint and GEN Matcher which are described further in this document.

### Execute Statement

The Execute Statement component 518 (and similarly the Execute Question component 520) automatically and dynamically sets the execution method in each GEN in the GEN Composite Statement before invoking it. It sets the execution method by looking up the most specialised and suitable method for the GEN as described in the Execution Selector.

The Statement Executer invokes the execute method on the GEN Composite Statement which triggers cascaded execution on all GENs in the GEN Composite 458. Calling the execute method causes multiple passes of execution as follows:
Execution First iteration: Executes the GEN Objects of each branch of the GEN Composite 458. This yields to the execution to Actor then Matter then Action. The First pass main logic to correctly identify the GEN and the Facts 524 related to the GEN composite 458 and performs co-referencing as described previously in the Question Execution method first iteration. For Actions, Calls the execution selector to link the GENs in GEN Composite 458 to either a programming language coded method or to an Augmenting GEN Composite. If linked to an Augmenting GEN Composite, then performs co-referencing to ensure the input statement specifics are propagated to the Augmenting GEN Composite.
Execution second iteration: Also executes the GEN Objects in the same order described above. The second pass execution performs the following:
   Creates the appropriate GEN Adjoin to link GEN Facts 524 other GEN Facts 524 and GEN Facts 524 to the GEN Ontology 526. The second pass execution sets the following Adjoin Annotations as described before.
   If a GEN Action, then the Execute Statement 518 looks for “DefinedAs” Adjoin, if found then it executes the GEN Composite 458 that is linked to the “DefinedAs” Adjoin.
   Otherwise, if the Action has the programming language coded execute method in the GEN. For example in the sentence “The system adds $10 to the account balance”, if the Action “add” has a hand-coded execute method, the method gets the identified Fact by the Matter “Account balance” in the first pass, read the value from the Fact 524 and mathematically add 10 to it.

### Execution Selector

There are a number of coded by programming language methods that are part of the start-up of GEN Engine 462 for executing a Statement or a Question. The coded by programming language methods including the most common mathematical functions, common verbs such “is”, “has”, “do”, “give”, “take”, “tell”, etc as well as an domain or specific systems interface that are required for GEN Actions are configurable and can be loaded from a configuration file 570 or set by an execution engine.

Also, method execution can be linked to and performed by Augmenting GEN Composite. Augmenting GEN Composites are more specialised than coded by programming language methods and they take precedent when selecting an executable function for a GEN as they are typically a further elaboration and refinement of the programming language methods. The previous example of a “transfer” Augmenting Action demonstrated an Augmenting GEN Composites that are defined from Natural Language text and converted into GEN Composites 458 ready to be linked to a GEN Object and to execute as further elaboration of the GEN Object. Augmenting a GEN composite Action is performed as follows:
The execution selector searches the GEN Knowledge for the most appropriate Action using:
   The most appropriate GEN Ontology Type in the domain.
   The most appropriate GEN Ontology Type with highest affinity to same or similar Actor and Matter. If found, it will have a higher affinity score than the above.
   The correct Semantic Context of the sentence as determined by the Sentence Normaliser. Determining, if the sentence is part of a question answering or part of executing a transaction with a system. Identification of the Actor and Matter typically result from the identification of the correct Facts or Ontology that need to be involved in the Action. Executing an Action might be just an informational recording of the Action or the actual invocation and performance of the Action. For example the word “withdraw” could be just a recording of a Fact told by a person or command to a system to perform the “withdraw” transaction. Taking into account the context will determine the Action, for example, if a “withdraw” word is in the context of a command from the teller to an IT system that performs the fixed term deposit or a savings account transaction. If found, it will have a higher affinity score than the above.
The search should return a list of possible definitions for the Action (Augmenting as well as any identified hard coded actions) sorted by affinity score.
If definition of the Action is not found, then the question is asked to the user who initiated the statement. Otherwise; The execution engine uses the found Action with top affinity score to augment the Action. The execution engine then performs the logic in the Execute Statement

### Applying Cause and Effect

As described before, the Cause and Effect is just a chained sequence of a Question and Statement where the Cause is formulated as a GEN Composite Question followed by an Effect which is formulated as GEN Composite Statement. When a Statement is executed, as shown in FIG. 13, the Comprehender 502 will check if any of the Cause-Effects 530 stored in the GEN Knowledge 527 matches the Statement. If true, then the Comprehender 502 will execute the Cause Question as shown in FIG. 7, if it return then it will execute the Statement in the Effect as shown in FIG. 8, passing all the maps found during executing the Cause.

### Sentence Normaliser

The Sentence Normaliser converts a GEN Composite that represents a simple, complex or compound sentence into a set of normalised GEN Composites interconnected with relationships to have equivalent sematic structure of the complex sentence.

A normalised GEN Composite has a simple AAM structure but has links via Adjoins to other normalised GEN Composites.

The Sentence normaliser is built using the GEN Engine, it has Cause-Effect rules that identifies implicit and explicit patterns of possession, conjunction, conditions, lists, comparison, temporal, etc. as well as the logic that enables the conversion of one sentence into a normalised and interrelated GEN Composites using Adjoins and Adjoins Annotations.

For example, “I have read Mike's new book”, would have two normalised sentence 1)“Mike has a new book” 2) “I have read that book”. With “that” is a co-reference to the book in the first normalised sentence.

Sentence Normaliser can be used to detect a passive sentence pattern and transforms the sentence into an active voice (a normalised form). Some passive voice sentence contains the Actor in the sentence which allows the Sentence Normaliser to transform patterns. While in other cases when the actor is not explicit; it can be inferred from conversation history or set with the annotation to indicate “to be resolved”.

The pattern recognition in combination of Cause Effect can be used to recognise common parser errors, common word annotation errors, users language errors, gaps and reorganise the GEN Composite with the correct structure. It can also be used for other application such as grouping of related sentences or making lists.

### Inference

Inference is needed when no direct answer is found or new Facts 524 are inserted and hence opportunities for inference could arise and for the Comprehender 502 to exploit. Cause-effect and chaining are explained in previous sections, this section of the documents describes Concept, Generalise, Analogy, Constraint and Common Sense inferences.

### Concept Maker

The Concept Maker 516 is a GEN Component that can create GEN a more generic GEN Composite/Facts 524 from specifics. It is invoked from the Core Comprehender 504 after the execution of a GEN Statement in order to find and create potential new concepts. To give examples, let's assume a new GEN Statement such as “John made a solid iron bed”. FIG. 9, shows the outcome of executing the Statement, a Fact model as represented by GEN Objects from 1.1 to 1.5. The newly created Facts 524 has the Usage Scenario=Fact and are made Coherent through a unique coherent ID.

After the Statement is executed, the core Comprehender 502 then invokes the Concept Maker 516 with a link to the executed Statement which in turns has Adjoins “hasDefinition” to the newly created Facts 524. The Concept Maker 516 tries to infer new Concepts from the new Facts 524 by searching for coherent Facts that share a common Assignable from (A Hypernym) GEN. The same logic for finding a concept also occurs when new GEN Composite 458 such as Cause- and Effect are inserted into the GEN Knowledge, the Comprehender 502 invokes the concept maker 516 to infer new concepts as a result of the newly inserted GEN Composites 458.

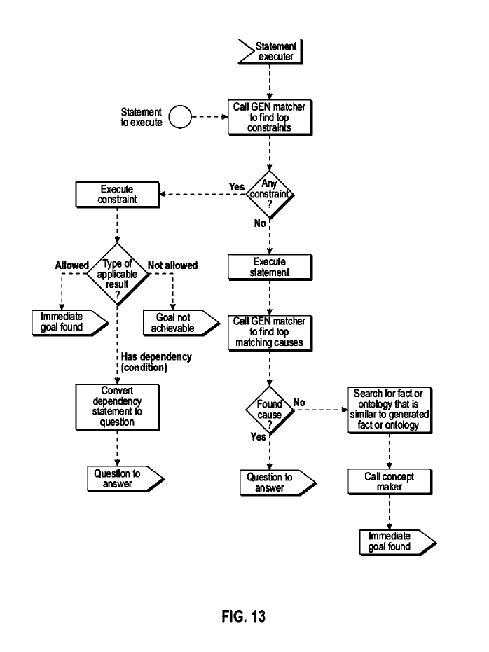

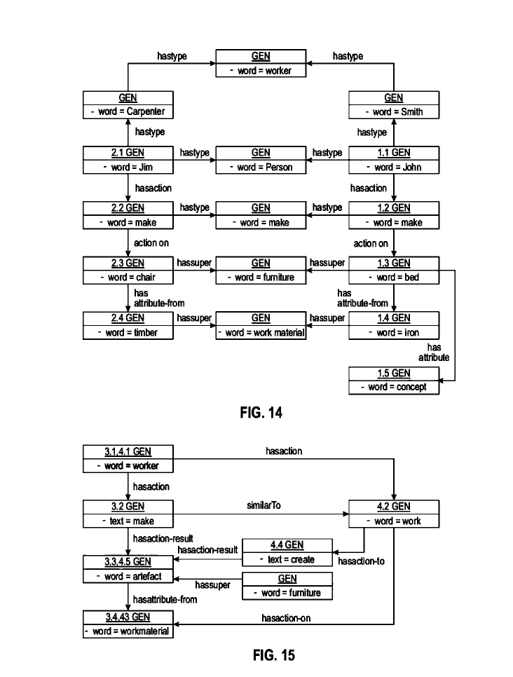

As an example, FIG. 14 illustrates an inferred Concept of Ontology GEN Objects 526 (3.1 to 3.4) that has Hypernym GENs for the GEN Composite 1.1 to 1.5 and 2.1 to 2.4 for FIG. 15.

In order to create such an inferred Concept, the Concept Maker 516 does the following:

1. The Concept Maker 516 calls the GEN matcher with search path parameter that encourages the return GEN Composite 458 with peers, similar, same or similar GENs. The GEN Matcher Component could return more than matching GEN-Composite sorted by Affinity score. The results effectively representing the similar GEN Composites 458 to the new Fact 524. The GEN Matcher will also return a map for every similar and peer GENs as described in the GEN Affinity.

2. For every matched similar GEN Composite 458:
Clone the GEN Composite 458 and replace its GEN objects with the equivalent source GEN from the map.
Set the GENs Confidence in the new GEN Composite 458 based on the affinity of the concepts to specifics multiplied with the default hypothetical percentage as per the configuration 570.
Get and set the total score for the new GEN Composite 458 by calculating the average score based on the weight of every GEN in it.
If the total score is above minimum score, return the Cloned and mapped GEN Composite 458 as a possible new concept.

3. Analogy Maker 514 issues the Question to the Execute Question component 520 but with path search

### Generaliser

Generaliser is also an inference function, it is a special behaviour of the Concept maker where it also account for general behaviour, average, median or sums the attributes of individual objects and work with as a group of generalised objects. For example, “I have 3 red apples, I bought 5 red apples”, the generaliser sums all the apples retrieved if a question such as “How many apples do you have?” is concerned about “many” and GEN Fact Apple. Effectively that question will be transformed into a goal “I have x.quantity apples” where x is the GEN that needs to be resolved (in this case summed) and it must be of a GEN Fact quantity. Once the goal is achieved by the question Executer, the result is a generalized fact.

Generalisation is a behaviour that is used by both the Question and the statement executer. The primary purpose of the generalisation is to be able to
Summarise and aggregate the Facts in the GEN Knowledge
Identify patterns from the Gen Knowledge, in a similar fashion to data mining using techniques such as Association Rule Learning. For example, “the user is more willing to do push-ups in the morning after tooth brushing”. Where “more willing” is an inferred generalised GEN Fact that was driven from associating the “push-up” action with the “brushing” action.
Generated generalisation facts are kept in the knowledge base and can be further refined with experience, for example the above fact can be further refined to “the user is more willing to do push-ups in the morning after tooth brushing and the user is not sick”.

Similar to concept, any learned new generalisations, are scored with low confidence; every confirmation of results by the user would accordingly increase the confidence in the generated generalization and the generaliser.

### GEN Analogy Maker

The Analogy Maker 514 is a GEN Component that can create new coherent GEN Facts/Composites as an analogy to already known coherent GEN Facts/Composites. It is one of the inference components that is invoked by the core Comprehender 502. The analogy maker 514 may help find answers to questions that are not directly available by deducing an answer based on similar known Facts/Composites. For example, assuming the GEN of making furniture is limited to the Facts 524 in FIG. 14 (not including the Concept in FIG. 15), the answer to question “Who makes stone furniture?” Will have no result as there as we assume no direct Facts 524 to that could provide the answer. The Analogy Maker 514 uses analogies to existing facts 524 in order to provide the answer as follows:

1. Analogy Maker 514 issues the Question to the Execute Question component 520 but with path search parameter that encourages the return GEN Composite 458 with peers, similar, same or similar GENs. The Execute Question Component 520 could return more than matching GEN-Composite 458 sorted by Affinity score. The results effectively representing the closest analogy to a hypothetical GEN Composite answer. The Execute question 520 will also return a map for every similar and peer GENs as described in the GEN Affinity.

2. For every returned GEN Composite 458:
Clone the GEN Composite answer and replace its GEN Objects with the equivalent source GEN from the map. This new GEN Composite 458 represents a new Hypothetical answer based on Analogy.
Set the GENs Confidence in the GEN Composite 458 with the Affinity of the Matched GEN Composite 458 multiplied by with the default hypothetical percentage as per the configuration 570.
Get and set the total score for the new GEN Composite 458 by calculating the average score based on the weight of every GEN in it.
If the total score is above minimum score, return the Cloned and mapped GEN Composite 458 as a possible answer.

While the above logic seem like software logic, assuming that “A” and “B” are Gen Composites 458, the analogy maker 514 function could be represented as a cause-effect statement “If A and B have many similar relations, and A has some relations and B does not have these relations; then, B may have relations similar to these relations”.

Based on the above Cause-Effect 530, the Analogy Maker 514 could be implemented by a GEN Engine 462.

### Execute Constraints

The Constraints 528 is an assertive sentence and hence Constraints 528 are Statements and also can be conditional Statements and hence can be also Cause-Effects 530.

Constraints 528 are checked and asserted every time a GEN Statement is executed or when a Question could not be answered directly from the Knowledge base. Since it is either a Statement or Cause-Effect 530, is execution is similar to what previously described, however the execution differ in the following ways:
Similar to a Cause, the search for Fact 524 starts with the Statement to execute
The result of the constraint 528 indicates:
   a) Constraint 528 applicable and execution granted
   b) Constraint 528 applicable and execution not granted
   c) Constraint 528 applicable and condition must be satisfied.
   d) Constraint 528 not applicable

### Executing Common Sense Logic

Common Sense work in a similar way to Constraints 528 and Cause Effect. The Common Sense Logic is checked and asserted every time a GEN Statement or Question is executed. There is no special annotation for Common sense logic as they are either stored as Constraints 528 or Cause-Effect 530. The Common Sense Knowledge is part of the start-up of a GEN Knowledge and potentially can be fed directly as general knowledge inferred by the Concept Maker 516 from fed knowledge.

As an example of the Common Sense GEN Composite 458 are represented in the following text (assuming that “A, B and C are GEN Composites 458): “If all A is B and C is A, then C is B.”

Assuming, Two GEN Statements were executed

1. “All living things are mortals”

2. “Mike is a person”.

When the Comprehender 502 received a GEN Composite Question represented by “Is Mike mortal?”, the Comprehender 502 will chain through this Common Sense, assign Actor and Object that are represented in the first statement (All living things, mortals) to A and B and Actor in the second statement (Mike) to C, and when both conditions (all A is B and C is A because Mike is a living thing) are met, it will return true.

### Finding GEN

Shortest Path is a known graph problem that has many algorithms to solve it such as Dijkstra's algorithm. The GEN Shortest Path is built on top of these algorithms and is a function that can be called from any component within the GEN Engine 462. This function calculates the distance between two GENs as the sum of the inverse of Weight of all GENs and Adjoins in the path between the two GENs. The effectively favours the components of highest Weight as well as less number of GEN Objects and Adjoins on the path.

The GEN Shortest Path function has additional important features that do not exist in the current algorithms:

1. It can take parameters which favour some Adjoins over others which effectively favours some paths over others. The parameters take a multiplier factor for certain types of links which will affects to the links weights during the distance calculation. For example, setting high multiplier Factor as parameters for “hasSuper” and “hasType” and low multiplier factor for “hasSub”; would favour conceptual affinity relations. Another example, adding high multiplier factor to “hasSuper-hasSub” pairs would favour peer affinity relations.

2. It can take the multiplier Factors for Strength, Priority and Confidence as Parameters, which allows changing the bias of the Path based to the higher multiplier factors.

### GEN Affinity

Gen Affinity builds on the on the GEN Shortest Path between two GENs. It is also a function available for all the components in the GEN Engine 462. GEN Affinity is the inverse of shortest path between corresponding GENs in two GEN Composites 458. The shorter the path between corresponding GENs in two GEN Composites 458, the higher the GEN Affinity. Corresponding GEN Objects in a two GEN Composites 458 can be determined by matching the corresponding AAM a GEN Composite 458 or with matching Adjoins. All corresponding pairs of GENs are kept in GEN Map that contains the following information
Source GEN
Destination GEN
Calculated distance from source to destination.
All path steps
Deduced source to destination relation (Similar, Hypernym, Hyponym, Peer, etc.)

In addition to the maps, the affinity function also calculates the Affinity total score between the two Gen Composites 458 which is a number that represents the median of distance between all corresponding GEN multiplied by the Weight of each node and penalty multiplier for non-matching GEN Objects.

### GEN Matcher

Gen Matcher is a search function which is available for any GEN Engine 462. Its purpose is to find a GEN Composite 458 with the closest Affinity to known GEN Composite 458. The Comprehender 502 often calls the GEN Matcher in order to find the next step in chaining The Gen Matcher receives the source GEN Composite 458 and the required Affinity Relation (Peer, Concept, etc.) and traverses the GEN Knowledge for matching GEN Composite 458 the highest affinity to the source Gen Composite 458.

### Session Context

The Session Context 510 a software component that is effectively a container that keeps tracks of all created GEN Composites 458 that are part of the interaction with the GEN Engine 462. All GEN objects in the Gen Composite 458 have links through the “hasDefinition” Adjoins to GEN Knowledge Facts 524 which effectively provides the Session Context 510 a focused view over the GEN Knowledge with Facts 524, Ontology 526 that is relevant to the current interaction between the GEN Engine 462 and its user.

The Session Context's 510 main purpose is to provide a reverse order chronological lookup for input GEN Composite 458 in order to help disambiguate and co-reference vague words by the Disambiguation, Sentence Normaliser and Executer components.

The Session Context 510 also holds key information such as: the current user, time, location, current active domain, and who is the current active voice in the conversation with the GEN Engine 462 and the active voice associated meta data including confidence.

### GEN Knowledge

This is a container for all GENs in a GEN Engine 462 which can be persisted in a graph database.

It has a register function to quickly find GEN Objects such as Ontology 526 entries, definition of actions, execution methods, etc. It provides traversal functions to find GEN Objects and GEN Composites 458 within the Knowledge.

It also provides statistical functions of most common occurrence for a word Role given other words of the triplet and context.

User Interaction with Natural Language GEN Engine

Referring back to FIG. 4, two key components of the system are depicted:

1. A user device 410 which receives user input; sends input to the Natural Language Composite GEN Engine 451; receives the results and provides the results to the user.

2. The Natural Language Composite GEN Engine 451 (NLC-GEN Engine) which receives natural language text from its users, processes them and return results in Natural Language Text.

### User Device

A user device 410 can be provided in the form of a personal computer, tablet processing system or smart phone which is capable of receiving user communication directly as text, text from voice via speech recognition software or text from image via image recognition software.

Software in the user device 410 can take user input as text, voice and image as described above and can act as the user input to the NLC-GEN Engine 451 by invoking an API over standard communication protocol to the NLC-GEN Engine 451 with the following input:
The user who is currently using the user device 410
The text input or converted text input from voice or image
Any additional information such as the device name type, the running application, metadata on voice, image or source document of text.
Feedback from the user to the GEN Engine 462 in the form of like, comment or corrections. This feedback is used by the optimiser 512 to fine tune the weights in the GEN in order to help providing more correct answers.

The NLC-GEN Engine 451 processes the input from the user device 410 and responds with a text indicating the result of the statement or question execution or to clarify the user input or get additional user input. The response from NLC-GEN Engine 451 is sent to the user device 410 to be shown as text or translated on emotional images on the device screen as well as converted to a voice if the original input was in the form of voice.

Once the API in the NLC-GEN Engine 451 receives a user input, it calls the Text Normaliser 452 to start the flow that will lead to a response to the user.

User device 410 may be configured to connect to one NLC-GEN Engine 451 or looks up an expert system for a given topic. In case of the user wants to select a specific expert engine, the user may enter the topic description. The directory services 495 then performs affinity calculation of the topic an returns the best matching affinity along with their past performance results.

### Text Normaliser

This component 452 leverages libraries that can process SMS, text message, emoticon, smiley, slang, chat room net lingo or abbreviations and translates it into plain text. There are many examples of such libraries that commercially available and open source. Having this component, enables the NLC-GEN Engine 451 to process text input from social and text media and directly from users who would prefer to communicate in this style of communication.

### Text to GEN Converter

This component 456 is built on top of GEN Engine 462, it converts text into a GEN Composite 458 including all the GEN attributes including annotations such as: POS, Named Entity and AAM as well as the linking Adjoins and its Annotations.

This component 456 is built by utilising a Natural Language Processing NLP software library and complement with additional logic to create the GEN Composite 458 for Statement or Question with the required structure and annotations as NLP does not provide GEN Composite 458 and annotations such as AAM.

The NLP software library is expected to create a parse tree structure that is similar but not the same as the GEN Composite 458 structure and with POS annotation that is focused on the grammar of the sentence.

In summary, this component has the responsibility to detect POS patterns using a patterns notation in the input sentences to give the pattern of the applicable GEN composite 458 structure and create the required GEN Composite 458 structure. If a pattern identified, this component uses another pattern based on the patterns notation to create the GEN Composite 458 Structure with AAM Annotation. This Component performs the following:

1—Identify a pattern of POS and the corresponding pattern of AAM in the sentence structure.

2—Perform Word Disambiguation to identify the correct sense of the word

3—Based on the identified pattern, map the elements of the POS pattern into AAM, create the GEN structure and set the AAM annotation accordingly.

4—If there are elements of the AAM annotation is missing, for example in “running down the street” or “dance with me” it can be mapped to the first example above where the GEN with Annotation Actor is created but marked with the text of “to be resolved”. The sentence Co-reference component will resolve it to a proper Actor.

5—Create the GEN Composite tree 458 by linking the GENs from parent to child with “hasChild” Adjoin and

6—As some phrases may contain a sentence, repeat the above steps to complete the GEN Composite 458.

7—Set the Coherent ID for sentence and sub-sentences.

8—Set the initial weight for each GEN as follows:
a. The strength with an initial value from the strength of the corresponding word sense in the ontology 526 multiplied by the active domain strength.
b. The priority with an initial value from the priority of the corresponding word sense in the ontology 526 multiplied by the current active priority and the applicable goal priority.
c. The confidence with an initial value from the confidence of the corresponding word sense in the ontology 526. Consequent trigger of Common Sense logic may alter the confidence level based on the evaluation of applicable common sense GEN Composites 458.

### Input Classification

The input GEN-Composite 458 to the Sentence Normaliser is expected to be annotated with Actor, Action Matter (AAM) as well as Complements and Groups. The Sentences Normaliser classifies input with Annotations such as: Question, Statement, Constraint 528 and Cause-Effect 530. It uses the Pattern Matcher described above to identify patterns of Question, Cause-Effect 530 and Constraint 528. If input was not classified as Question, Cause-Effect 530 or Constraint 528, the input Gen Composite 458 remains with the Statement Annotation.

The identification patterns are hand coded and part of the GEN Engine 462 that operates the Sentence Normaliser. All the learning approach described above will also apply to the further build on and optimise the hardcoded patterns.

### Semantic Context

Semantic context is also determined by the Sentence Normaliser. The semantic context contains:
Domain: as per the expert engine domain
Category of speech: fiction, non-fiction, Joke, etc.
Type of speech: Providing information, request for action, action result.

The semantic context is calculated by the Sentence Normaliser through pattern detection, the execution of Cause-Effect and constraints, on input sentence. The values in the Sematic Context is added as an annotation to each sentence (the root GEN Composite that has annotation of statement or question).

### Communicator

The Communicator's 460 key responsibility is to dispatch input GEN Composite 458 to interested GEN Engines 462. The Communicator 460 keeps a map each connected GEN Engine 462 to the Communicator 460 along with A GEN Composite 458 of the GEN Engine scope and any events that the GEN Engine 462 is subscribing too. The GEN Engine 462 is connected to the Communicator 460 by configuration where the transport mechanism is a standard synchronous or asynchronous transport mechanism that allows GEN Composite 458 to be serialised or tunnelled through the standard transport mechanism. The setup of the connection between the Communicator 460 and GEN Engines 462 can be configured by the Communicator's 460 own GEN Engine configuration file 570 or by discovery through directory service server 495 that maintains a map of the scope of GEN Engine 462, its transport mechanism information and its overall performance results. The connection a GEN Engine 462 and another can also be overlayed with standard security mechanisms over transport protocols and application servers and such as strong authentication, keys and certificates.

Once the Communicator 460 receives an input GEN Composite 458, it checks if it has any correlation ID to a recipient GEN Engine 462 which is effectively the scope of a GEN Engine 462, if it exists then it checks against the GEN engine scope and forwards it to the GEN Engine 462 with that scope. Otherwise, it checks the affinity of the Composite 458 to the scope Statement of all GEN Engines 462 that it communicates to, and then it sends the input message to the GEN Engine 462 with the best n scores as per the configuration file value 570.

The communicator 460 may also have the responsibility to stamp the sender correlation ID as well as its transport information on outgoing messages so that results could be returned back asynchronously based on the correlation ID and transport information.

### Domain Expert Engine(s)

Expert Systems use Knowledge representation to facilitate the codification of knowledge into a knowledge base which can be used for reasoning, i.e., we can process data with this knowledge base to infer conclusions. This expert system is built on top a GEN Engine 462 which has the knowledge for a particular domain. Each expert system domain defined by a scope statement: As a retail Banks example “Retain bank is a financial institution that serves its customer by providing them with transaction for depositing, withdrawing and transferring money, paying bills, signing up for a credit or debit cards and currency exchange. The retail banks also provide loan facilities that include personal, car and home loans.”

A domain also have goals, each goals are given a priority. The goals are also written in Natural Language, represented and priority sorted as GEN Composite 458.

Since every domain expert engine 462 is defined by a scope statement, the scope statement is shared among all GEN Engine Experts 462 in one NLC GEN Engine 451. NLC can publish all its Experts Scope Statements in a directory service 495.

The domain also have default for the three weight attributes (strength, confidence and priority) as well as the current active attributes. Theses attributes can be altered by Cause-Effect GEN Composites 530 as described earlier.

### Knowledge in the Expert Engine

Facts 524 and Ontologies as described before that are relevant to the GEN Engine Expert Scope Statement.

### Domain Expert Directory

The directory 495 is a registry for Domain Exert Engines 462 which are expert systems that are running in an accessible network from the director server. The key elements of the directory 495 are:
Owner of the Domain Expert Engine 462
Domain Scope
Domain default strength, priority and confidence
Goals of the expert engine 462 that drives the priority of its execution
Feedback from human users
Overall ratings score and goals achievements score
Best Features of the engine 462
Worst Features of the engine 462
Transport and security information for connecting to the engine 462.

### Examples of the Applications of the Embodiments

The embodiment details the method of accepting user input in natural language, finding executable functions using the underlying knowledge, executing the functions, updating the underlying knowledge and inferring from the updated knowledge. This method effectively enriches the underlying knowledge including the executable functions from the user input and from inferences.

A natural language executable expert system is an application of the method where human experts enter and execute their expert knowledge in natural language in the processing system and publish (allow) their knowledge to be accessed by human end users. Human end users can take advantage of this published knowledge by accessing the processing system through their own devices. Human users can ask questions, allowing the processing system to monitor their events; the processing system utilises the outlined method to execute the received input text and provide answers to the end users' questions and events. Human end users may also enter their own knowledge through a user device in order to further elaborate the stored knowledge. As examples for applying the natural language executable expert system:
a. Service access point, where experts define the service knowledge for a particular service (such as mobile phone service center, holiday booking service center, jury duty help line, etc. . . . ) using the natural language executable expert system so that human end user ask that exert system questions about the service and or request the service. The natural language expert system responds to the answers as per its stored knowledge.
b. Companion, where human experts create the knowledge that contains the common human behavior and different traits of human personalities in the natural language expert system that is published to human end users as an artificial companion to human beings. Human end users can use it by further customising the desired traits of the artificial companion and start entering information about everything that the human end user wants to teach to the artificial companion. The artificial companion will respond to the human end user as per the human expert entered knowledge and the human end user customised traits and entered knowledge.

Many modifications will be apparent to those skilled in the art without departing from the scope of the present invention.

What is claimed is:

1. A computer implemented method for natural language execution, wherein the method includes, in a processing system, steps of:
(a) receiving input data indicative of natural language text;
(b) using a natural language processor to generate natural language parse information based on the input data;
(c) generating, using the natural language parse information, an input object composite including a plurality of linked objects, wherein each object represents a word or group of words of the input text;
(d) determining, for the objects of the input object composite and using an object knowledge network stored in a data store, a plurality of interpretation object composites that represent interpretation functions to interpret the respective word or group of words represented by each object;
(e) executing each interpretation function to modify one or more objects of the input object composite;
(f) determining, for the objects of the input object composite and using the object knowledge network, executable object composites that represent executable functions to execute actions associated with the objects representing the input text;
(g) executing the executable functions thereby generating an output object composite;
(h) updating the object knowledge network based on the input object composite, the output object composite and the execution of each interpretation and execution function represented by the respective interpretation and executable object composites; and
(i) outputting, based on the output object composite, output data indicative of natural language text.

2. The method according to claim 1, wherein the step of determining the plurality of interpretation object composites includes searching the object knowledge network to identify if interpretation object composites that represent the interpretation functions exists for each object.

3. The method according to claim 2, wherein in response to failing to identify the interpretation functions for one of the objects, the step of determining the plurality of interpretation object composites further includes attempting to infer the interpretation object composites that represent the interpretation functions using an inference engine and based on the object knowledge network.

4. The method according to claim 3, wherein the interpretation functions for each object are only executed in the event that the plurality of interpretation functions for all objects of the object composite have been identified or inferred.

5. The method according to claim 4, wherein in the event that the interpretation function for all objects cannot be successfully identified or inferred, the step of determining the plurality of interpretation object composites further includes:
(j) generating and outputting a request to a user for clarification of the respective word or group of words represented by a remainder of the objects which the respective interpretation function cannot be identified or inferred;
(k) receiving clarification text from the user, wherein the clarification text is natural language text;
(l) using the natural language processor to generate the natural language parse information based on the clarification text;
(m) performing steps (c) to (h) to for the natural language parse information generated based on the clarification text; and
(n) inferring or identifying the interpretation function for the remainder of the objects which previously could not be inferred or identified.

6. The method according to claim 5, wherein in the event that at least some of the interpretation functions associated with the clarification text cannot be identified or inferred, the step of determining the executable object composites further includes recursively performing steps (j) to (n) in relation to a further clarification request until the interpretation function associated with the further clarification text can be inferred or identified thereby allowing inference or identification of one or more interpretation functions which previously could not be inferred or identified.

7. The method according to claim 1, wherein the plurality of interpretation functions include:
a. sentence normaliser functions;
b. word and sentence disambiguation functions; and
c. co-reference functions.

8. The method according to claim 1, wherein the method includes normalizing the input data using a text normalizer prior to generating the input object composite.

9. The method according to claim 1, wherein the method includes selecting an object engine from a plurality of object engines to perform steps (d) to (h).

10. The method according to claim 9, wherein each object engine includes a scope definition, wherein the method includes:
generating a plurality of lexical affinity scores for the input object composite based on the scope definition of the plurality of object engines; and
selecting one of the object engines with the best lexical affinity score.

11. The method according to claim 1, wherein the step of determining the executable object composites include searching the object knowledge network to identify if an executable object composite representing the execution function exists for each object.

12. The method according to claim 11, wherein in response to failing to identify the execution function for one of the objects, the step of determining the executable object composites further includes attempting to infer the execution function based on the object knowledge network.

13. The method according to claim 11, wherein each execution function for the plurality of objects is only executed in the event that the execution function for all objects of the input object composite have been identified or inferred.

14. The method according to claim 13, wherein in the event that the execution function for all objects cannot be successfully identified or inferred, the step of determining the executable object composites further includes:
(o) outputting a request for clarification of the respective word or group of words represented by at least some of the objects which the respective execution function cannot be identified or inferred;
(p) receiving clarification text, wherein the clarification text is natural language text;
(q) using a natural language processor to generate the natural language parse information based on the clarification text;
(r) attempting to perform steps (c) to (h) for the natural language parse information generated based on the clarification text; and
(s) in the event that plurality of the execution functions associated with the clarification text are determined and executed, the method includes inferring or identifying the execution function for the at least some of the objects which previously could not be inferred or identified.

15. The method according to claim 14, wherein in the event that at least some of the execution functions associated with the clarification text cannot be identified or inferred, the step of determining the executable object composites further includes recursively performing steps (o) to (s) in relation to a further clarification request until the interpretation function associated with the further clarification text can be inferred or identified thereby allowing inference or identification of one or more interpretation functions which previously could not be inferred or identified.

16. The method of claim 1, wherein the method includes the processing system executing a software application performs the steps of the method, wherein the software application is an executable object composite.

17. A processing system for natural language execution, wherein the processing system is configured to:
receive input data, wherein the input data is natural language text;
use a natural language processor to generate natural language parse information based on the input data;
generate, using the natural language parse information, an input object composite including a plurality of linked objects, wherein each object represents a word or group of words of the input text;
determine, for the objects of the input object composite and using an object knowledge network stored in a data store, a plurality of interpretation object composites that represent interpretation functions to interpret the respective word or group of words represented by each object;
execute each interpretation function to modify one or more objects of the input object composite;
determine, for the objects of the input object composite and using the object knowledge network, a plurality of execution object composites that represent executable functions to execute actions associated with the objects representing the input text;
execute the executable functions, thereby generating an output object composite;
update the object knowledge network based on the input object composite, the output object composite and the execution of each interpretation and execution function represented by the respective interpretation and executable object composites; and
output, based on the output object composite, output data indicative of natural language text.

18. A computer readable medium for configuring a server processing system for natural language execution, wherein the computer readable medium includes executable instructions from executable object composites which, when executed, configure the server processing system to:
receive input data, wherein the input data is natural language text;
use a natural language processor to generate natural language parse information based on the input data;
generate, using the natural language parse information, an input object composite including a plurality of linked objects, wherein each object represents a word or group of words of the input text;
determine, for the objects of the input object composite and using an object knowledge network stored in a data store, a plurality of interpretation object composites that represent the interpretation functions to interpret the respective word or group of words represented by each object;
execute each interpretation function to modify one or more objects of the input object composite;
determine, for the objects of the input object composite and using the object knowledge network, a plurality of execution object composites that represent executable functions to execute actions associated with the objects representing the input text;
execute the executable functions, thereby generating an output object composite;
update the object knowledge network based on the input object composite, the output object composite and the execution of each interpretation and execution function represented by the respective interpretation and executable object composites; and
output, based on the output object composite, output data indicative of natural language text.

19. A system for natural language execution, wherein the system includes:
the processing system according to claim 17; and
a user device in data communication with the processing system, wherein the user device is configured to:
transfer the input data to the processing system; and
receive the output data from the processing system.

20. The system according to claim 19, wherein the user device is configured to:
generate the input data based upon one of:
text data input via a first input device of the user device image data captured via a second input device of the user device; and
audio data captured via a third input device of the user device; and
process the output data to generate at least one of:
textual output presented via a first output device of the user device; and
audio output presented via a second output device of the user device.
